(19) United States
(12) Patent Application Publication
(10) Pub. No.: US 2020/0061789 A1
(43) Pub. Date: Feb. 27, 2020

(54) FLYWHEEL-DRIVEN SETTING TOOL AND METHOD FOR OPERATING SUCH A SETTING TOOL

(71) Applicant: HILTI AKTIENGESELLSCHAFT, Schaan (LI)

(72) Inventors: Tilo DITTRICH, Feldkirch (AT); Dominik SCHMIDT, Feldkirch (AT); Raphael THON, Wiener Neustradt (AT)

(21) Appl. No.: 16/461,568

(22) PCT Filed: Nov. 13, 2017
(86) PCT No.: PCT/EP2017/079031

§ 371 Date: May 16, 2019

(30) Foreign Application Priority Data
Nov. 18, 2016 (EP) 16199457.9

(51) Int. Cl. B25C 1/06; B25C 1/00

(52) U.S. Cl. CPC B25C 1/06; B25C 1/008

(57) ABSTRACT

A flywheel-driven setting tool comprising a flywheel which can be drivingly connected to a drive-in element by a coupling device in order to drive a securing element into an underlying surface during a setting process using the drive-in element, wherein the drive-in element is accelerated out of a starting position in a setting direction. In order to allow securing elements to be driven into the underlying surface in a consistent manner, the coupling device is paired with an actuator, by which the coupling device can be opened.

### TECHNICAL FIELD

The invention relates to a flywheel-driven setting device comprising a flywheel which can be drivingly connected to a driving element by means of a coupling device in order to drive a fastening element into a substrate during a setting process using the driving element, wherein the driving element is accelerated out of a starting position in a setting direction. The invention also relates to a method for operating such a setting device.

### PRIOR ART

The European publications EP 2 716 409 A2, EP 2 711 135 A2 and EP 2 433 752 A2 disclose various setting tools, which produce a frictional connection between a plunger and a flywheel during a setting process, in order to transmit rotational energy from the flywheel to the plunger.

### SUMMARY OF THE INVENTION

The object of the invention is to simply enable a uniform driving of fastening elements into a substrate by means of a flywheel-driven setting device according to the preamble of claim 1, in particular with the least possible user effort.

The object is achieved in a flywheel-driven setting device comprising a flywheel which can be drivingly connected to a driving element by means of a coupling device in order to drive a fastening element into a substrate during a setting process using the driving element, wherein the driving element is accelerated out of a starting position in a setting direction, in that an actuator is associated with the coupling device, wherein the coupling device can be opened by the actuator, for example in case of a jammed coupling. The flywheel-driven setting device is preferably a hand-held setting device, which is also referred to as a setting tool. The setting elements or fastening elements are, for example, nails or bolts which are driven into the substrate by means of the setting device, which is also referred to as a setting tool.

The setting energy is advantageously provided by an electric motor and transmitted via the flywheel to the driving element, which is also referred to as a setting plunger. For this purpose, the flywheel is rotated by the electric motor. The rotational energy of the flywheel is transmitted to the driving element, in particular the setting plunger, which is also abbreviated as plunger, in order to perform a setting process. With the help of the driving element, in particular of the plunger, the fastening element is driven into the substrate. In order to transmit the rotational energy from the flywheel to the driving element, the flywheel is initially connected in a frictional engagement with the driving element, for example by means of a suitable coupling device. For this purpose, the driving element can be arranged between the flywheel and a counter-roller. After the driving element has driven a setting element or fastening element into the substrate, the coupling device is opened to release the driving element from the flywheel. Thereafter the driving element is returned to its starting position by a return device, for example a return spring device. The coupling device may be self-reinforcing, such as an oblique wheel coupling, in order to provide a high normal force on the driving element in the direction of the flywheel. The returning of the driving element by the return device usually works properly when the driving element is in a correct arrangement or position after the setting process. An undesired mispositioning of the driving element can lead to jamming of the coupling device, in particular in the case of coupling devices with self-reinforcement. The coupling device is then wedged, so to speak, and the driving element does not return to its starting position. The mispositioning of the driving element, which is also referred to as setting plunger or plunger, is also referred to as plunger mispositioning. Such a plunger mispositioning occurs in particular when driving setting elements or fastening elements into a wood substrate. In wood applications, due to natural material inhomogeneities, for example in the form of knotholes, an increased plunger mispositioning rate or coupling clamping rate occurs, which is undesirable. The flywheel-driven setting device with the actuator associated with the coupling device and/or the method for operating the flywheel-driven setting device advantageously allow for an automatic correction of a mispositioning of the driving element, in particular a mispositioned plunger or a jammed coupling in the setting device. As a result, a uniform operation with the least possible user effort can be ensured.

A preferred exemplary embodiment of the flywheel-driven setting device is characterized in that a detection device is associated with the driving element, through which detection device a mispositioning of the driving element can be detected. The detection of the mispositioning of the driving element can be achieved in various ways. After the detection of the mispositioning of the driving element, the jamming of the coupling device, in particular a self-locking of the coupling device, is eliminated by the actuator.

A further preferred exemplary embodiment of the flywheel-driven setting device is characterized in that the detection device comprises a driving element end position switch, a sensor for detecting a movement, a stroke and/or a position of the driving element, a sensor for detecting a rotational angle and/or a rotational speed of the flywheel, and/or a sensor for detecting a state of the coupling device. The driving end position switch detects or senses whether the driving element has again reached its starting position, in particular its rearward position. A sensor for detecting the stroke of the driving element, in particular for the detection of the plunger stroke, detects the stroke of the driving element and thus the position of the driving element and determines if the driving element has not reached its starting position, in particular its rearward arrangement or position after a certain period of time. By means of the sensor for detecting the angle of rotation and/or the speed of the flywheel it can be detected or sensed whether the flywheel has stopped. A stationary flywheel indicates a mispositioning of the driving element. By means of the sensor for detecting a state of the coupling device, the operating state of the coupling can be detected or sensed. If the driving element is not returned to its starting position, the coupling device has generally jammed and is not in its starting position.

A preferred exemplary embodiment of the flywheel-driven setting device is characterized in that the coupling device is coupled or combined with a contact rod assembly in such a way that the coupling device is automatically opened upon withdrawing the setting device from the substrate. For this purpose, the coupling device is combined, for example, with a ratchet device. By means of the ratchet device and the contact rod assembly, an automatic release or opening of the coupling device can be performed in a simple manner upon withdrawing the setting device from the substrate.

In a method for operating a flywheel-driven setting device comprising a flywheel which can be drivingly connected to a driving element by means of a coupling device in order to drive a fastening element into a substrate during a setting process using the driving element, wherein the driving element is accelerated out of a starting position in a setting direction, in particular a flywheel-driven setting device as previously described, above mentioned object is achieved in that the coupling device is opened after the setting process, so that the driving element is returned again into its starting position, for example by means of a return device. The coupling device is automatically opened after the setting process, so that a user of the setting device is not required to do anything to eliminate an undesirable mispositioning of the driving element. If the coupling device is actively or forcibly opened after each setting process, a detection of a mispositioning of the driving element can be omitted.

For example, a reset is automatically carried out each time the setting device is removed from the substrate, whereby the coupling device is completely released so that any self-locking that has occurred is eliminated. The forced or active opening of the coupling device is performed, for example, by a previously described actuator, which is associated with the coupling device.

A preferred exemplary embodiment of the method is characterized in that the coupling device is opened as soon as a defined time interval has elapsed after a trigger actuation or after an actuation of a contact switch. In order to open the coupling device, for example, the previously described actuator is actuated, which eliminates a jamming of the coupling device. The contact switch advantageously detects when the setting device is pressed against the substrate.

A further preferred exemplary embodiment of the method is characterized in that the coupling device is opened by a device-internal actuator in case of a jammed coupling and/or in case of a mispositioning of the driving element. The device-internal actuator includes, for example, an actuator ram with which a jammed coupling device can be actively or forcibly opened or released. The actuator ram cooperates, for example, with a wedge of the coupling device. The wedge of the coupling device serves, for example, to press a counter-roller of the coupling device against the driving element in such a way that the driving element is in turn pressed against the flywheel in order, for example, to frictionally connect the flywheel to the driving element.

A further preferred exemplary embodiment of the method is characterized in that a movement, a stroke and/or a position of the driving element is/are monitored in order to detect a mispositioning of the driving element. The monitoring of the movement of the stroke and/or the position of the driving element is preferably carried out automatically by means of a previously described detection device. This provides the advantage that a user of the setting device can work undisturbed.

A further preferred exemplary embodiment of the method is characterized in that the coupling device is mechanically opened after withdrawing the setting device from the substrate. The automatic opening of the coupling device is achieved, for example, by a contact rod assembly which is coupled or combined with the coupling device.

The invention further relates to a coupling device, an actuator, a driving element, a detection device, a sensor, a driving element end position switch and/or a contact rod assembly for a previously described setting device. The parts mentioned may be handled separately.

Further advantages, features and details of the invention will become apparent from the following description in which, with reference to the drawings, various embodiments are described in detail. In particular:

FIG. 1 shows a simplified illustration of a flywheel-driven setting device with a flywheel which is spaced apart from a driving element before a coupling release;

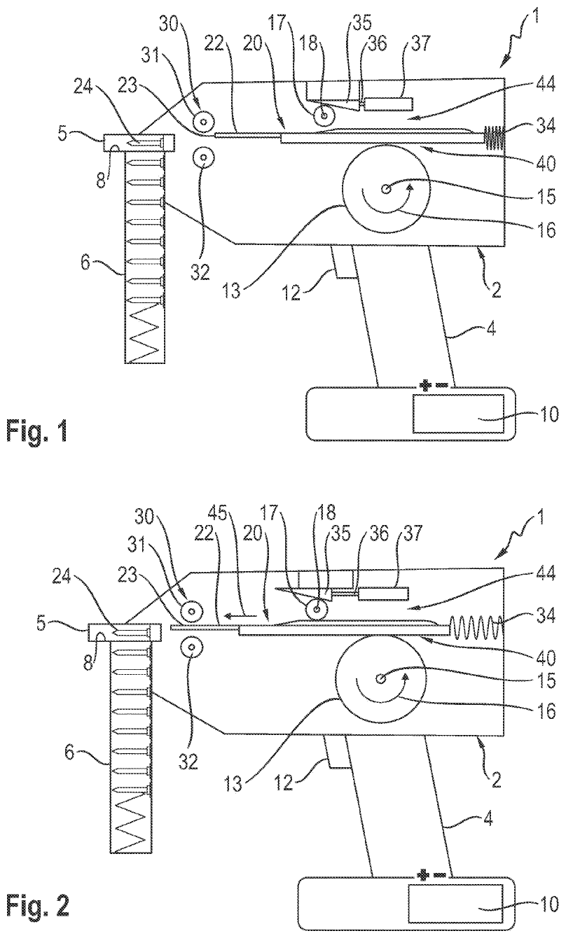

FIG. 2 shows the setting device of FIG. 1, wherein the driving element is frictionally connected to the flywheel after a coupling release;

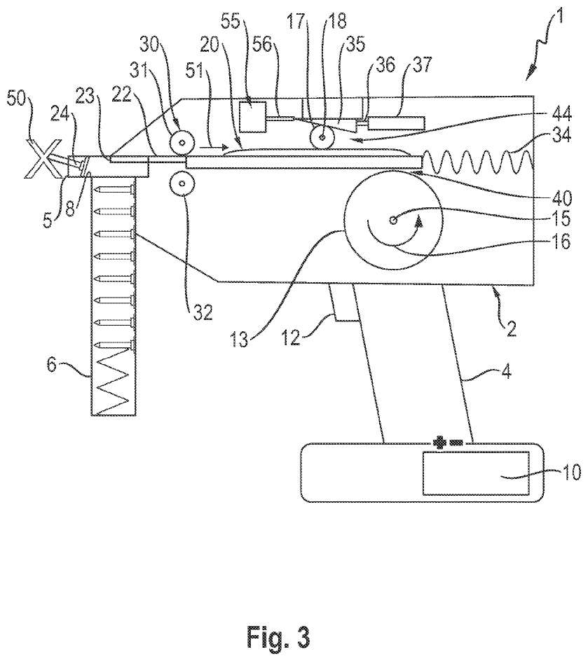

FIG. 3 shows the setting device of FIG. 2 in the event of a mispositioning of the driving element with an additional actuator which is associated with the coupling device and through which the coupling device can be opened, for example in the case of a jammed coupling;

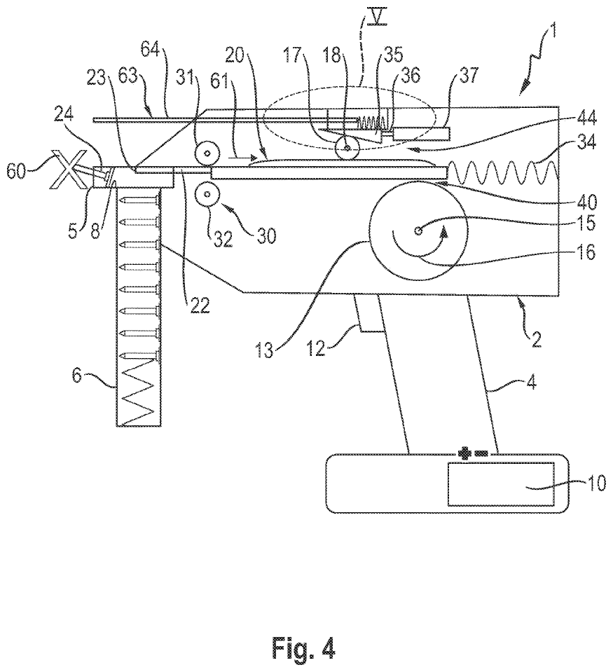

FIG. 4 shows a setting device similar to the one in FIG. 3 in the case of a mispositioning of the driving element, the coupling device being coupled to a contact rod assembly such that the coupling device is automatically opened when the setting device is withdrawn from the substrate;

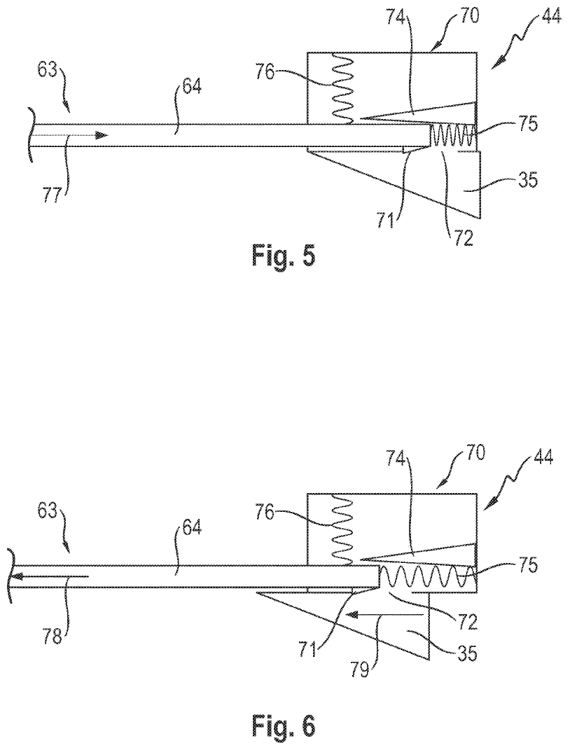

FIG. 5 shows an enlarged view of a detail V of FIG. 4;

FIG. 6 shows the detail of FIG. V when loosening or opening the coupling device and

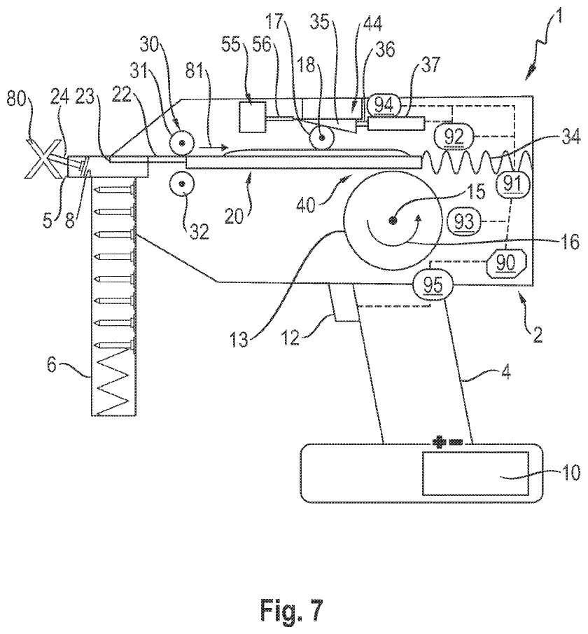

FIG. 7 shows the setting device of FIG. 3 with different examples of a sensor system for the detection of a mispositioning of the driving element.

### EXEMPLARY EMBODIMENTS

In FIGS. 1 and 2, a flywheel-driven setting device 1 having a housing 2 is shown in a simplified manner. The setting device 1 is designed as a hand-operated setting device with a handle 4 and a setting end 5.

The setting device or setting tool 1 is used for driving fastening elements 24 into a substrate (not shown). A desired number of fastening elements 24 is stored in a magazine 6 at the setting end 5. The fastening elements 24 are individually provided from the magazine 6, preferably automatically, into a bolt guide 8.

The energy required for driving in the fastening elements 24 is provided, for example, in the form of electrical energy in an accumulator 10 at the lower end of the handle 4. The electrical energy stored in the accumulator 10 is converted into rotational energy by means of an electric motor (not shown), which is advantageously integrated in a flywheel 13.

By means of this rotational energy, the flywheel 13 is rotated about a flywheel rotation axis 15, as indicated by an arrow 16 in FIGS. 1 and 2. Upon actuation of a trigger or operating knob 12 on the handle 4, a coupling integrated into the setting device 1, which is designed, for example, as an oblique wheel coupling, is closed such that the rotational energy stored in the flywheel 13 is is transmitted to a driving element 20 to initiate the setting process as translational energy.

The driving element 20 represents a setting plunger 22, which is also referred to as a plunger. The setting plunger 22 or driving element 20 is arranged between the flywheel 13 and a counter-roller 17.

The counter-roller 17 is rotatable about a counter-roller rotation axis 18, which is arranged parallel to the flywheel rotation axis 15. The counter-roller 17, together with the flywheel 13 and the driving element 20 arranged therebetween, constitutes a coupling device 44 which, as will be explained below, is actuated via an electromagnet 37.

The setting plunger 22 has at its left end in FIGS. 1 and 2 a plunger tip 23, with which the fastening element 24 can be driven into the substrate (not shown) at the setting end 5 of the setting device 1. The setting plunger 22 or the driving element 20 is guided in the setting device 1 by means of at least one plunger guide 30 as to be movable back and forth in the axial direction, i.e. to the left and to the right in FIGS. 1 and 2.

The plunger guide 30 comprises two guide rollers 31, 32. In order to drive the fastening element 24, the setting plunger 22 is moved with its plunger tip 23 toward the fastening element 24 with great acceleration by the plunger guide 30. After a setting process, the setting plunger 22 is moved back into its starting position shown in FIGS. 1 and 2 by means of a return spring 34.

The coupling device 44 in the setting device 1 comprises a wedge 35, which is movable with a ram 36 by the electromagnet 37 in order to press the counter-roller 17 in FIG. 1 downwards against the driving element 20. In FIG. 1, the setting device 1 is shown before a coupling release.

FIG. 1 shows the setting device 1 immediately before a setting process. The flywheel 13 has been set into rotation, for example, by an integrated brushless electric motor and thus has an energy in the form of rotational energy, as indicated by the arrow 16 in FIG. 1.

In FIG. 2, the coupling device 44 is actuated via the electromagnet 37 so that the driving element is pressed by the counter-roller 17 downwards against the flywheel 13. As a result, a frictional engagement between the flywheel 13 and the driving element 20 is produced in a connecting region 40.

The frictional engagement causes rotational movement of the flywheel 13 indicated by the arrow 16 to be transmitted to the driving element 20 so that the latter is moved in a setting direction indicated by an arrow 45 in FIG. 2 to the left towards the fastening element 24 in the bolt guide 8. As soon as the driving element 20 strikes the fastening element 24 with the plunger tip 23, the fastening element is driven into the substrate at the setting end 5 of the setting device 1.

In FIG. 3, a cross 50 indicates that the fastening element 24 was not driven correctly into the substrate due to an inhomogeneity in the substrate, for example. By means of the return device or return spring 34, a force indicated by an arrow 51 acts on the driving element 20. However, as shown in FIG. 3, the driving element 20 cannot be reset correctly due to an undesired clamping or jamming of the coupling.

In order to remove the mispositioning of the driving element 20, which is also referred to as plunger mispositioning, the coupling device 44 in FIG. 3 can be opened by an actuator 55. The actuator 55 comprises an actuator ram 56, which rests with a free end on a tip 55 of the wedge 35 of the coupling device 44, which faces the actuator 55.

Upon a movement of the actuator ram 56 in FIG. 3 to the right, the coupling device 44 is actively or forcibly released by a corresponding movement of the wedge 35. After releasing the coupling device 44 (not shown in FIG. 3), the driving element 20 or setting plunger 22 can be returned by the spring force of the return spring 34 into its starting position shown in FIG. 1. Thereafter the setting device 1 is back in its defined starting state and is ready for a new setting.

FIG. 4 shows a setting device 1 similar to the one shown in FIG. 3. A cross 60 in FIG. 4 indicates that the fastening element 24 was not driven or was incorrectly driven into the substrate. As shown in FIG. 3, an arrow 61 indicates a restoring force, which is exerted by the return spring 34 on the driving element 20. A mispositioning of the driving element 20 is eliminated in FIG. 4 in that a contact rod assembly 63 with a contact rod 64 automatically releases the jammed coupling device 44 when the setting device 1 is withdrawn from the substrate.

FIG. 5 shows an enlarged detail V of FIG. 4. In FIGS. 5 and 6, a ratchet 71 is provided at a right end of the contact rod 64. The ratchet 71 represents a kind of barb, with which the contact rod 64 engages in a corresponding recess 72 on the upper side of the wedge 35 of the coupling device 44.

In FIGS. 5 and 6, the right end of the contact rod 64 is guided between the wedge 35 of the coupling device 44 and a guide body 74 so that the ratchet 71 is pressed into the recess 72. The contact rod 64 basically hooks to the wedge 35.

The ratchet 71 forms a ratchet device 70 with the guide body 74, a compression spring 75 and a tension spring 76. By means of the tension spring 76, the right end of the contact rod 64 in FIG. 5 is held in contact with the guide body 74. The compression spring 75 is compressed or squeezed in case of a movement of the contact rod 74 to the right, as indicated by an arrow 77 in FIG. 5. In this case, the ratchet 71 hooks to the wedge 35 of the coupling device 44, as can be seen in FIG. 5.

In FIG. 6, an arrow 78 indicates, that the previously compressed compression spring 75 causes a movement of the contact rod 64 to the left in FIG. 6, as soon as the setting device comprising the contact rod assembly 63 is withdrawn from the substrate. A further arrow 79 indicates that the contact rod 64, which is moved to the left in FIG. 6, entrains the wedge 35 via the ratchet 71, in order to forcibly and actively release or open the coupling device 44. Thus, each time wetting the setting device 1, the coupling device 44 is automatically opened. As a result, the driving element always returns to its starting arrangement or starting position and the setting device is ready for the next setting cycle.

FIG. 7 shows a setting device 1 similar to the one in FIG. 3, comprising an actuator 55, which is associated with the coupling device 44. An arrow 80 indicates that the fastening element 24 was not driven or was not properly driven into the substrate. An arrow 81 indicates a force, which is applied by the return spring 34 to the driving element 20. The coupling device 44 is jammed, so that the driving element 20 is mispositioned or the setting plunger 22 has a plunger mispositioning.

A symbol 90 indicates a device for the detection of a plunger mispositioning comprising a controller. The controller of the detection device 90 is connected for control purposes with an end position switch 91 and with optional sensors 92 to 94.

The limit switch 91 senses or detects when the driving element 20 or the setting plunger 22 is in its starting position or in its end position, as shown in FIG. 1. The sensor 92 can detect a stroke of the driving element 20 during operation of the setting device 1.

A rotational speed or a rotational angle of the flywheel 13 can be detected by means of the sensor 93. The sensor 94 can sense or detect a state, in particular a jamming, of the coupling device 44.

A symbol 95 related to the control is arranged in FIG. 7 between the trigger 12 and the controller 90. The symbol 95 represents a defined time interval At. By means of the controller 90, the coupling device 44 can be actively or forcibly opened after the expiration of the time period or time interval At after a trigger actuation or after activating/deactivating a contact switch. The opening of the coupling device 44 takes place, for example, by means of the actuator 55 and the actuator ram 56.

1. A flywheel-driven setting device for driving a fastening element into a substrate during a setting process, the setting device comprising a driving element, a coupling device, and a flywheel, which can be drivingly connected to the driving element by the coupling device in order to drive the fastening element into the substrate, wherein the driving element is accelerated out of a starting position in a setting direction, the setting device also comprising an actuator associated with the coupling device, wherein the coupling device can be opened by the actuator.

2. The flywheel-driven setting device according to claim 1, further comprising a detection device associated with the driving element, wherein the detection device can detect mispositioning of the driving element.

3. The flywheel-driven setting device according to claim 2, wherein the detection device comprises a driving element end position switch, a sensor for detecting a movement, a stroke and/or a position of the driving element, a sensor for detecting a rotation angle and/or speed of the flywheel and/or a sensor for detecting a state of the coupling device.

4. The flywheel-driven setting device according to claim 1, wherein the coupling device is coupled with a contact rod assembly such that the coupling device is automatically opened upon withdrawing the setting device from the substrate.

5. A method for operating a flywheel-driven setting device for driving a fastening element into a substrate during a setting process, the setting device comprising a driving element, a coupling device, and a flywheel, which can be drivingly connected to the driving element by the coupling device in order to drive the fastening element into the substrate, wherein the driving element is accelerated out of a starting position in a setting direction, the setting device also comprising an actuator associated with the coupling device, wherein the coupling device can be opened by the actuator, the method comprising accelerating the driving element out of a starting position in a setting direction, opening the coupling device after the setting process, and returning the driving element into the starting position of the driving element.

6. The method according to claim 5, comprising opening the coupling device as soon as a defined time interval has elapsed after actuating a trigger or after actuating a contact switch of the setting device.

7. The method according to claim 5, comprising opening the coupling device by the actuator in case of a jammed coupling and/or in case of a mispositioning of the driving element.

8. The method according to claim 5, including monitoring a movement, stroke and/or position of the driving element in order to detect a mispositioning of the driving element.

9. The method according to claim 5, comprising mechanically opening the coupling device after withdrawing the setting device from the substrate.

10. A coupling device, actuator, driving element, detection device, sensor, driving element end position switch and/or contact rod assembly for the setting device according to claim 1.

11. The method according to claim 5, comprising returning the driving element into the starting position by a return device.

12. The flywheel-driven setting device according to claim 2, wherein the coupling device is coupled with a contact rod assembly such that the coupling device is automatically opened upon withdrawing the setting device from the substrate.

13. The flywheel-driven setting device according to claim 3, wherein the coupling device is coupled with a contact rod assembly such that the coupling device is automatically opened upon withdrawing the setting device from the substrate.

14. The method according to claim 6, comprising opening the coupling device by the actuator in case of a j ammed coupling and/or in case of a mispositioning of the driving element.

15. The method according to claim 6, including monitoring a movement, stroke and/or position of the driving element in order to detect a mispositioning of the driving element.

16. The method according to claim 7, including monitoring a movement, stroke and/or position of the driving element in order to detect a mispositioning of the driving

17. The method according to claim 6, comprising mechanically opening the coupling device after withdrawing the setting device from the substrate.

18. The method according to claim 7, comprising mechanically opening the coupling device after withdrawing the setting device from the substrate.

19. The method according to claim 8, comprising mechanically opening the coupling device after withdrawing the setting device from the substrate.
